(19) United States
(12) Patent Application Publication
(10) Pub. No.: US 2017/0310617 A1
(43) Pub. Date: Oct. 26, 2017

(54) SOCIAL INFORMATION PROCESSING PROGRAM, SOCIAL INFORMATION PROCESSING DEVICE, AND SOCIAL INFORMATION PROCESSING METHOD

(71) Applicant: Tetsuya WADA, Ibaraki-shi (JP)

(72) Inventor: Tetsuya WADA, Ibaraki-shi (JP)

(21) Appl. No.: 15/518,738

(22) PCT Filed: Oct. 9, 2015
(86) PCT No.: PCT/JP2015/078854

§ 371 Date: Jun. 30, 2017

(30) Foreign Application Priority Data
Oct. 13, 2014 (JP) 2014-209557

(51) Int. Cl. H04L 12/58

(52) U.S. Cl. CPC H04L 51/046; H04L 51/36; H04L 51/12; H04L 51/32

(57) ABSTRACT

It is an object to provide a processing program, a processing device, and a processing method for extracting social information that meets a predetermined extraction condition from social information posted on the Internet, and enabling handling in the same way as exchange of electronic mail.

A social information processing device 10 is configured by installing a social information processing program in a computer 20. The social information processing device 10 includes an electronic mail communication processing unit 30 that performs communication by electronic mail, a message extraction processing unit 44 that extracts social information that meets a predetermined extraction condition from social information posted on the Internet, and a display processing unit 50 capable of displaying the social information extracted by the message extraction processing in an identical user interface to the electronic mail related to the electronic mail communication processing.

### RELATED APPLICATIONS

This application is the U.S. National Phase of and claims priority to International Patent Application No. PCT/JP2015/078854, filed on Oct. 9, 2015, which claims priority under 35 U.S.C. §119 to Japanese Patent Application No. 2014-209557, filed on Oct. 13, 2014, which are incorporated herein by reference in their entirety.

### TECHNICAL FIELD

The present invention relates to a processing program, a processing device, and a processing method for extracting and processing social information that satisfies predetermined conditions from social information posted on the Internet.

### BACKGROUND ART

In recent years, with the development of the Internet, electronic mail has become an essential tool as a method for transmitting information in company activities. Conventionally, for example, the electronic mail system disclosed in Patent Literature 1 (Unexamined Japanese Patent Publication No. 2013-77922) described below has been used in companies and the like.

Meanwhile, services related to social networks, such as mini blogs (micro blogs) and social networking services called SNS, have been provided and have become popular as new communication tools. In such services, information is not transmitted to and received from a specified person as in electronic mail, but information is posted toward a large number of general public. Therefore, information posted on social networking services or the like has a characteristic that an information transmission speed is fast and that the information is easy to spread.

### SUMMARY OF THE INVENTION

As described above, the information posted on social networking services or the like will spread quickly and over a wide range toward a large number of general public regardless of whether the information is true. Accordingly, when information favorable to or information positive for a product or service provided by a company is sent to social networking services or the like, recognition of the product or service may improve tremendously, and sales may skyrocket. On the other hand, there is even a possibility that, if inappropriate information, negative information, and the like caused by complaints or misunderstandings made by third parties are sent to social networking services or the like, regardless of whether the information is true, a bad image is created for the product or service provided by the company, and the company falls into an irreversible situation. Therefore, in a site of sales activities or customer support of a company, it is desired to construct an environment in which not only electronic mail but also social information posted on social networking services or the like can be quickly acquired and used effectively.

It is therefore an object of the present invention to provide a processing program, a processing device, and a processing method for making it possible to extract, from social information posted on the Internet, social information that satisfies a predetermined extraction condition and to handle the extracted social information in the same way as exchange of electronic mail.

A social information processing program of the present invention provided to solve the above-described challenge is capable of performing: private information processing for processing private message information to be exchanged with a specified party; information extraction processing for extracting social information that satisfies a predetermined extraction condition from social information posted on the Internet; and display processing capable of displaying the social information extracted by the information extraction processing in an identical user interface to the private message information related to the private information processing.

According to the social information processing program of the present invention, it is possible to perform the information extraction processing and to extract the social information that satisfies the predetermined extraction condition from the social information flooding on the Internet. In addition, it is possible to display the extracted social information in the identical user interface to the private message information related to the private information processing. Therefore, according to the social information processing program of the present invention, it becomes possible to handle the social information in the same way as the private message information, and to handle the social information and the private message information in a unified way. Accordingly, not only information by the private message information but also the social information posted on the Internet can be used effectively.

In the above-described social information processing program of the present invention, it is preferable that electronic mail communication processing related to communication by electronic mail be included in the private information processing, and that the electronic mail be handled as part or all of the private message information.

In the social information processing program of the present invention, it becomes possible to process electronic mail, which is private message information, by private information processing, and it becomes possible to handle electronic mail in the same way as social information and to handle electronic mail and social information in a unified way. Accordingly, it becomes possible to effectively use exchange of electronic mail as well as social information posted on the Internet.

Here, social information posted on the Internet includes various types of information, not only favorable information and positive information, but also inappropriate information, negative information, and the like caused by complaints or misunderstandings made by third parties. There is even a possibility that when so-called bad information, such as complaints, inappropriate information, and negative information is left unaddressed, this will spread as an unexpected rumor, information different from reality, or the like, which may lead to a total mess-up. Meanwhile, when an appropriate response is made in an early stage where these pieces of bad information begin to appear, not only the spread of the bad information can be resolved but also there is even a possibility that new information is posted that praises appropriateness of the response. Therefore, the above-described social information processing program of the present invention is desirably capable of smoothly responding to the social information posted by a third party on the Internet.

The social information processing program of the present invention provided based on the above-described knowledge is capable of performing one or both of: reply processing for sending new social information related to a reply to the social information extracted by the information extraction processing; and citation sending processing for sending new social information citing the extracted social information.

The social information processing program of the present invention can also send a reply to the social information extracted by the information extraction processing and send new social information citing the social information. That is, the social information processing program of the present invention can send new information based on the social information extracted by the information extraction processing. This makes it possible to smoothly respond to the social information posted by a third party on the Internet.

The above-described social information processing program of the present invention is desirably capable of arbitrarily performing condition setting processing for setting the extraction condition.

With such a configuration, it is possible to extract social information that meets a desired extraction condition and to utilize the extracted social information for business or the like.

Here, with the above-described social information processing program of the present invention, it is possible to read the social information extracted by the information extraction processing in the identical user interface to the private message information; however, in order to make it easier to read and increase convenience, it is desirable to give further contrivance.

The social information processing program of the present invention provided based on such knowledge is capable of performing thread display processing for displaying the private message information and the social information having predetermined relevance to each other together in a single thread.

The social information processing program of the present invention can display the private message information and the social information relevant to each other together in a single thread by performing the thread display processing. Accordingly, it becomes possible to collectively read the private message information and the social information, further improving convenience.

Note that in the present invention and the following description, “thread” refers to electronic mail or social information related to one topic collected and displayed so as to be collectively readable. For example, replies or citation replies to electronic mail or social information that are collected so as to be collectively readable correspond to a thread.

Here, as described above, when highly relevant private message information or social information extracted based on a common extraction condition can be displayed together in a single thread, it is considered that extraction, from the thread, of part of the private message information or social information included in the thread and collection into a separate thread will further improve convenience.

The social information processing program of the present invention provided based on such knowledge is capable of performing a thread dividing process for displaying part of the private message information or the social information constituting the thread, and the private message information or the social information related thereto, collected in a different thread independent of an existing thread.

With such a configuration, part of the private message information or the social information collected in the existing thread can be divided into a new thread and handled. Thus, convenience of the social information processing program can be further improved.

It is desirable that the above-described social information processing program of the present invention allows the private message information and the social information to be shared among computers connected to a predetermined network.

By allowing the private message information and the social information to be shared among computers connected to a predetermined network as in the present invention, it is possible to perform work while checking what kind of response users of the social information processing program in other computers have made to the private message information and the social information. Accordingly, it is possible to share the social information and the private message information posted on the Internet with other users, thereby improving work efficiency and convenience.

The above-described social information processing program of the present invention is also capable of performing estimation processing based on one or both of the social information and the private message information extracted by the information extraction processing, and setting the extraction condition based on a result of performing the estimation processing.

The social information processing program of the present invention can set the extraction condition by estimation based on the social information or the private message information. Therefore, according to the present invention, it is possible to achieve improvement in efficiency and optimization of the extraction condition setting.

With the above-described social information processing program of the present invention, while the private message information and the social information can be read in the identical user interface, in addition thereto, it is desirable that message exchange information that is exchanged in real time, such as chat, can be read in the identical interface.

The social information processing program of the present invention provided based on such knowledge is further capable of performing information acquisition processing for acquiring the message exchange information that is exchanged in real time on the Internet, and the display processing is capable of displaying the message exchange information acquired by the information acquisition processing in the identical user interface.

With such a configuration, the private message information, the social information, and the message exchange information are displayed in the identical user interface, and for example, it is possible to discuss response to the private message information or the social information with other users in real time easily and simply by message exchange.

The above-described social information processing program of the present invention is capable of granting, to the private message information or the social information, guest connection permission information for temporarily granting, to a guest user who does not have connection authority to a specified message exchange site for exchanging the message exchange information, the connection authority.

With such a configuration, since the guest connection permission information is granted to the private message information or the social information, even the guest user who does not have the connection authority to the message exchange site can connect to the message exchange site, and can easily exchange messages without application for granting authority to the message exchange site.

The social information processing program according to the present invention is capable of transmitting, to the guest user, a record concerning the message exchange information recorded by connecting to the specified message exchange site based on the guest connection permission information, as private message information.

With such a configuration, the record concerning the message exchange information is transmitted to the guest user as private message information. Although the guest user who does not have the connection authority to the message exchange site typically cannot read information on past message exchange, when messages are exchanged by the social information processing program of the present invention, the record concerning the message exchange information is transmitted and information on the message exchange can be read.

The above-described social information processing program of the present invention is capable of performing exchange information transmission processing for transmitting a record concerning the message exchange information as private message information.

With such a configuration, it is possible to share a history and contents of the message exchange information simply and easily with other users.

In addition, a social information processing device of the present invention includes: a private information processing unit configured to perform private information processing related to communication by private message information; an information extraction processing unit configured to extract social information that satisfies a predetermined extraction condition from social information posted on the Internet; and a display processing unit capable of displaying the social information extracted by the information extraction processing unit in an identical user interface to the private message information related to the private information processing.

The social information processing device of the present invention can extract the social information that satisfies the predetermined extraction condition from a lot of pieces of social information that exist on the Internet by the information extraction processing unit. In addition, through processing by the display processing unit, the social information extracted by the information extraction processing can be displayed in the identical user interface to the private message information related to the private information processing. Therefore, the social information processing device of the present invention can handle the social information and the private message information in a unified way. Accordingly, the social information posted on the Internet can be effectively used as well as information based on the private message information. In addition, by extracting social information on a plurality of social networking services from each social networking service, the user has no trouble accessing every social networking service to extract the social information.

Here, in the above-described social information processing device of the present invention, although the private message information and the social information can be read in the identical user interface, in addition thereto, it is desirable that the message exchange information exchanged in real time can be read in the identical interface by using the message exchange service such as a chat service.

The social information processing device of the present invention provided based on such knowledge further includes an exchange information acquisition processing unit capable of acquiring the message exchange information that is exchanged in real time on the Internet, and the display processing unit is capable of displaying the message exchange information acquired by the exchange information acquisition processing in the identical user interface.

With such a configuration, the private message information, the social information, and the message exchange information are displayed in the identical user interface, and for example, it is possible to discuss response to the private message information or the social information with other users in real time easily and simply by message exchange.

A method for processing social information of the present invention includes: performing private information processing related to communication based on private message information; performing information extraction processing for extracting social information that satisfies a predetermined extraction condition from social information posted on the Internet; and performing display processing capable of displaying the social information extracted by the information extraction processing in an identical user interface to the private message information related to the private information processing.

According to the method for processing social information of the present invention, both the private message information obtained by private information processing and the social information extracted by information extraction processing can be displayed in the identical user interface and managed in a unified way. Accordingly, not only information based on the private message information but also the social information posted on the Internet can be effectively used.

Here, in the above-described method for processing social information of the present invention, although the private message information and the social information can be read in the identical user interface, in addition thereto, it is desirable that the message exchange information exchanged in real time can be read in the identical interface by using the message exchange service such as a chat service.

The method for processing social information of the present invention provided based on such knowledge is further capable of performing exchange information acquisition processing for acquiring the message exchange information that is exchanged in real time on the Internet, and the display processing is capable of displaying the message exchange information acquired by the exchange information acquisition processing in the identical user interface.

With such a configuration, the private message information, the social information, and the message exchange information are displayed in the identical user interface, and for example, it is possible to discuss response to the private message information and the social information with other users easily and simply in real-time by message exchange.

According to the present invention, it is possible to provide a processing program, a processing device, and a processing method for making it possible to extract, from social information posted on the Internet, social information that satisfies a predetermined extraction condition and to handle the extracted social information in the same way as exchange of private message information.

### BRIEF DESCRIPTION OF THE DRAWINGS

FIG. 1 is an illustrative diagram illustrating an outline of a social information processing device and a method for processing social information to be implemented using a social information processing program according to a first embodiment of the present invention.

FIG. 2 is a block diagram illustrating a configuration of the social information processing device illustrated in FIG. 1.

FIG. 3 is an image diagram illustrating one example of an interface to be displayed in the social information processing device illustrated in FIG. 1.

FIG. 4 is a flowchart illustrating one example of an operation of the social information processing device illustrated in FIG. 1.

FIG. 5 is a flowchart illustrating one example of the operation of the social information processing device illustrated in FIG. 1.

FIG. 6 is an image diagram illustrating a top screen to be displayed by executing the social information processing program according to a first example of the present invention.

FIG. 7 is an image diagram illustrating a comment field displayed in the top screen of FIG. 6.

FIG. 8 is an image diagram illustrating a timeline display screen to be displayed by executing the social information processing program according to the first example of the present invention.

FIG. 9 is an image diagram illustrating a dashboard screen to be displayed by executing the social information processing program according to the first example of the present invention.

FIG. 10 is an image diagram illustrating a person in charge distribution interface to be displayed by executing the social information processing program according to the first example of the present invention.

FIG. 11 is an illustrative diagram illustrating an outline of a social information processing device and a method for processing social information to be implemented using a social information processing program according to a second embodiment of the present invention.

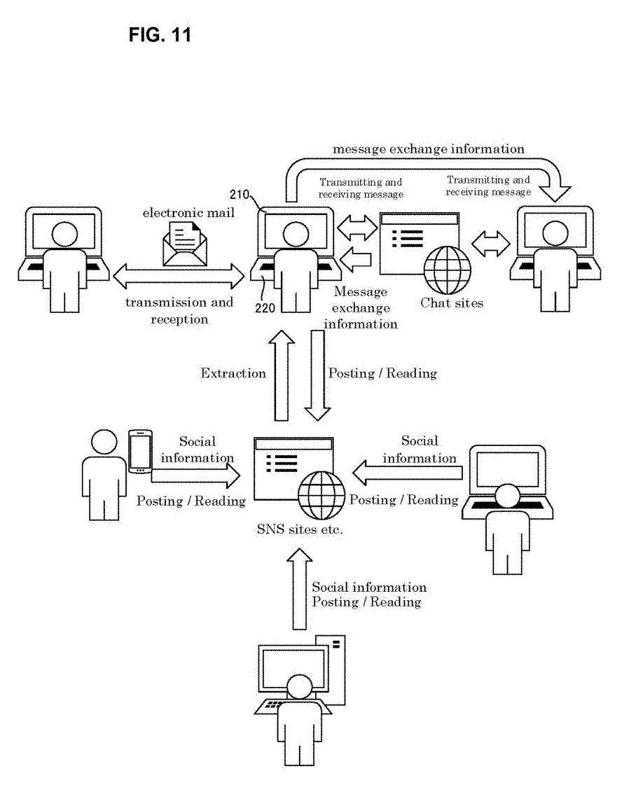

FIG. 12 is a block diagram illustrating a configuration of the social information processing device illustrated in FIG. 11.

FIG. 13 is an image diagram illustrating one example of an interface to be displayed in the social information processing device illustrated in FIG. 11.

FIG. 14 is a flowchart illustrating one example of an operation of the social information processing device illustrated in FIG. 11.

FIG. 15A is an image diagram illustrating one example of an image to be displayed on a guest user terminal side by executing the social information processing program according to a second example of the present invention. FIG. 15B is an image diagram illustrating one example of an image to be displayed in a state where message exchange via a message exchange site has become possible.

### DESCRIPTION OF EMBODIMENTS

### First Embodiment

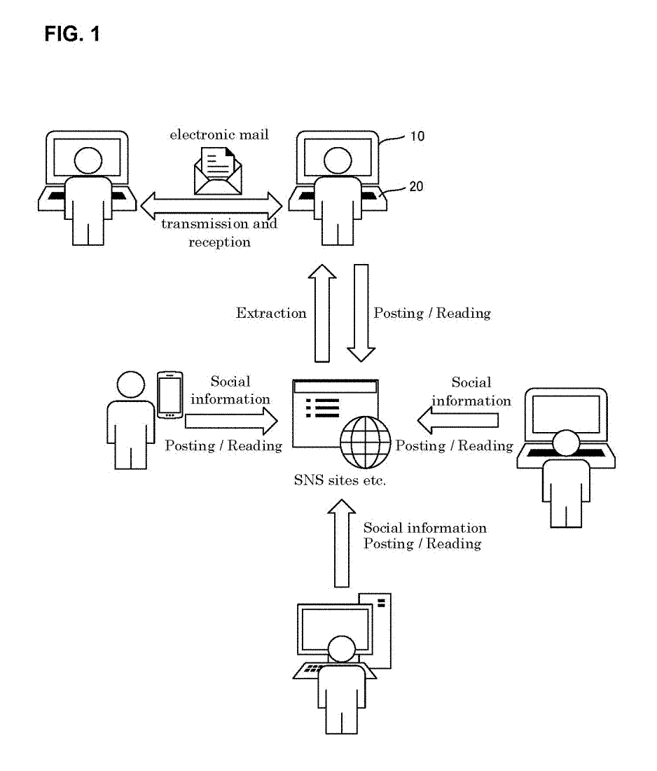

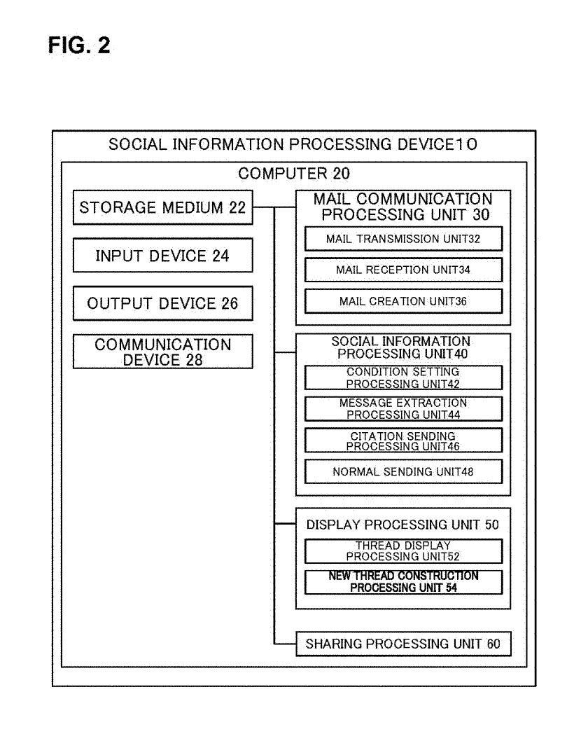

To begin with, a social information processing device 10, a social information processing program, and a method for processing social information according to a first embodiment of the present invention will be described in detail with reference to the drawings. As illustrated in FIG. 1, the social information processing device 10 performs the method for processing social information of the present invention. In the social information processing device 10, functional components as illustrated in FIG. 2 are constructed in a computer 20 by installing the social information processing program of the present invention in a storage medium 22, such as a hard disk or a solid state drive (SSD), included in the computer 20. The social information processing device 10 can be used via an input device 24 included in the computer 20, such as a mouse and a keyboard, or an output device 26, such as a monitor. In addition, via a communication device 28 included in the computer 20, the social information processing device 10 can connect to a communication network and perform communication, such as an Internet network, a local area network (LAN), a wide area network (WAN), and a virtual private network (VPN).

FIG. 2 is a block diagram illustrating one example of the functional components of the social information processing device 10. As illustrated in FIG. 2, the social information processing device 10 includes an electronic mail communication processing unit 30 (private information processing unit), a social information processing unit 40, a display processing unit 50, and a sharing processing unit 60 as the functional components.

The electronic mail communication processing unit 30 performs processing (electronic mail communication processing, private information processing) regarding communication (transmission and reception) by electronic mail, which is private message information. The electronic mail communication processing unit 30 has a configuration similar to a configuration of conventionally known electronic mail software. Specifically, the electronic mail communication processing unit 30 includes components such as an electronic mail transmission unit 32, an electronic mail reception unit 34, and an electronic mail creation unit 36. The electronic mail transmission unit 32 performs information processing for electronic mail transmission. The electronic mail reception unit 34 performs information processing for electronic mail reception. The electronic mail creation unit 36 implements an electronic mail-creating function. Data on received or transmitted electronic mails processed by the electronic mail communication processing unit 30 and electronic mails that are being created is processed by the display processing unit 50, which will be described in detail later, so as to be displayable in a predetermined user interface. The data is then displayed on the output device 26, such as a monitor.

The social information processing unit 40 processes social information posted on the Internet. The social information processing unit 40 has a function to extract social information that meets an arbitrary extraction condition from countless pieces of social information, and to handle the extracted social information in a similar manner to electronic mail. Here, the social information to be handled by the social information processing unit 40 refers to information posted on a service or website that can construct a social network, such as a mini blog (micro blog) and a social networking service called SNS, for example. Accordingly, the social information is not information sent toward specified people as in electronic mail, but information sent for purposes of being read by unspecified people. That is, the social information differs from electronic mail in that the social information is not information sent toward users of the social information processing device 10.

The social information processing unit 40 includes components such as a condition setting processing unit 42, an information extraction processing unit 44, a reply-citation sending processing unit 46, and a normal sending unit 48. The social information handled by the social information processing unit 40 is processed by the display processing unit 50, which will be described in detail later, so as to be displayable in a predetermined user interface. The social information is then displayed together with electronic mail on the output device 26, such as a monitor.

The condition setting processing unit 42 performs a process for setting an extraction condition (condition setting process) for extracting desired social information from countless pieces of social information posted on the Internet. As the extraction condition that can be set by the condition setting processing unit 42, various conditions can be employed, such as a condition that an arbitrary keyword, such as a company name, product name, and service name, is included or not included, date and time when the social information is posted, gender of a person who makes the post, and positional information where the post is made, for example.

The information extraction processing unit 44 performs a process for extracting social information that satisfies the extraction condition set by the condition setting processing unit 42 from social information posted on the Internet (information extracting process). A processing method for extracting a message performed by the information extraction processing unit 44 is not limited to a particular method, and for example, a conventionally known search engine or the like may be used to search for a message.

The reply-citation sending processing unit 46 replies to the social information extracted by the information extraction processing unit 44, and posts new social information that cites social information. The social information sent by the reply-citation sending processing unit 46 is posted on the Internet via the communication device 28 included in the computer 20.

The normal sending unit 48 sends social information to be normally posted on a service or website such as a mini blog or SNS, not in connection with the social information extracted by the information extraction processing unit 44.

The display processing unit 50 processes electronic mail or social information processed by the electronic mail communication processing unit 30 or the social information processing unit 40 so as to be displayable in a predetermined user interface on the output device 26, such as a monitor. The display processing unit 50 can display electronic mail and social information together in an identical user interface. The display processing unit 50 includes a thread display processing unit 52 and a new thread construction processing unit 54.

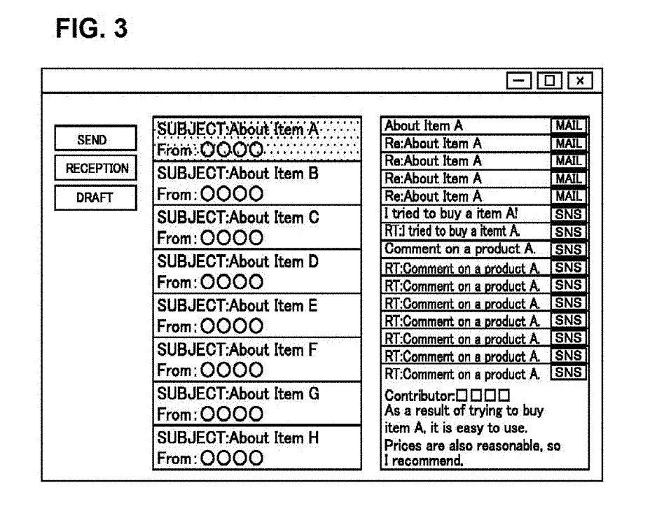

The thread display processing unit 52 performs a process for selecting electronic mail and social information that have predetermined relevance to each other, and then displaying the electronic mail and social information together as a single thread, for example, in a form illustrated in FIG. 3 (thread display process). When a reply or citation post is made to a first electronic mail or social information that describes predetermined information, the thread display processing unit 52 forms a thread automatically. In addition, when another reply or citation post is made to this reply or citation post, the thread display processing unit 52 collects this reply or citation post into the thread formed earlier. In this way, the thread display processing unit 52 collects electronic mail or social information into an existing thread or constructs a new thread.

Here, the relevance of electronic mail or social information that serves as a criterion for constructing a thread (hereinafter also referred to as “thread construction criterion”) can be set on various conditions. Specifically, various conditions can be employed as the thread construction criterion, such as a predetermined keyword specified by a user being included in a title (subject name) or body text, date and time when the social information is posted, gender of a person who makes the post, positional information where the post is made. A user may be allowed to arbitrarily set the thread construction criterion, or the thread display processing unit 52 may set the thread construction criterion automatically in accordance with a predetermined algorithm.

The new thread construction processing unit 54 performs a process for collecting electronic mail or social information related to part of electronic mail or social information that constitutes an existing thread into another thread independent of the existing thread for display (thread dividing process). Specifically, when the new thread construction processing unit 54 selects part of electronic mail or social information that constitutes an existing thread, the new thread construction processing unit 54 sets a new thread construction criterion (hereinafter also referred to as “new thread construction criterion”) on the basis of the selected electronic mail or social information. From the electronic mail or social information that constitutes the existing thread, the new thread construction processing unit 54 performs a process for selecting electronic mail or social information that meets the new thread construction criterion, and then collecting the selected electronic mail or social information into another thread for display.

The sharing processing unit 60 performs a process for sharing information about electronic mail or social information among a plurality of social information processing devices 10 connected to a predetermined network. Specifically, data of electronic mail or social information is synchronized among the plurality of social information processing devices 10 connected to a communications network, such as a local area network (LAN), a wide area network (WAN), and a virtual private network (VPN). Accordingly, even when exchange of electronic mail or social information is made in any social information processing device 10 connected to the network, the information can be checked by other social information processing devices 10 as well.

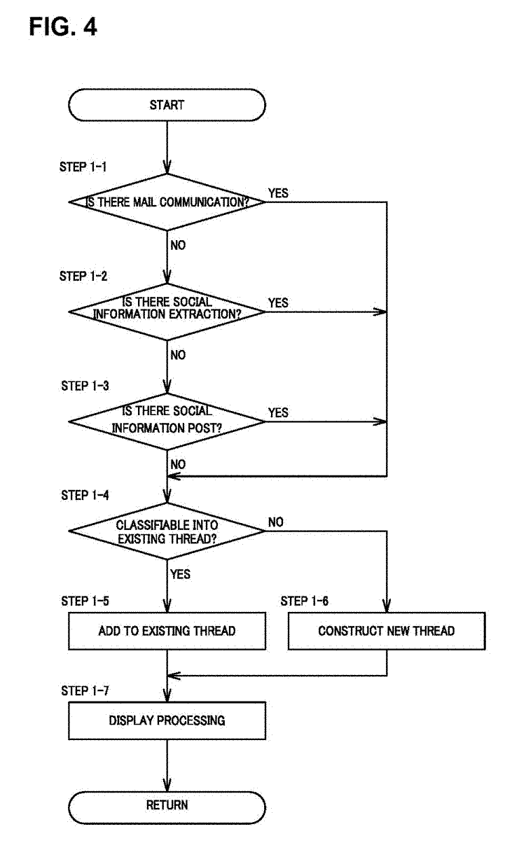

Next, in the method for processing social information to be performed by the above-described social information processing device 10, an information processing flow of displaying electronic mail or social information in a thread will be described in detail with reference to a flowchart of FIG. 4.

### (Step 1-1)

To begin with, in step 1-1, it is confirmed whether communication (transmission and reception) of electronic mail has been carried out by the electronic mail communication processing unit 30. When communication by electronic mail has been carried out, a control flow proceeds to step 1-4, whereas when communication by electronic mail has not been carried out, the control flow proceeds to step 1-2.

### (Step 1-2)

In step 1-2, it is confirmed whether social information that meets the extraction condition that is set in advance has been extracted by the information extraction processing unit 44 of the social information processing unit 40. Here, when it is confirmed that new social information has been extracted, the control flow proceeds to step 1-4. On the other hand, when new social information has not been extracted, the control flow proceeds to step 1-3.

### (Step 1-3)

In step 1-3, it is confirmed whether a user of the social information processing device 10 has posted social information with the reply-citation sending processing unit 46 or the normal sending unit 48 of the social information processing unit 40. Here, when it is confirmed that social information has been posted, the control flow proceeds to step 1-4. On the other hand, when it is not confirmed that social information has been posted by the user of the social information processing device 10, the control flow returns to step 1-1.

### (Step 1-4)

In step 1-4, the thread display processing unit 52 confirms whether the electronic mail or social information newly confirmed in step 1-1 to step 1-3 described above can be classified into an existing thread. That is, it is confirmed whether the new electronic mail or social information confirmed in step 1-1 to step 1-3 meets a classification condition into an existing thread (thread construction criterion). Here, when the new electronic mail or social information can be classified into an existing thread, the control flow proceeds to step 1-5, whereas when the new electronic mail or social information cannot be classified into an existing thread, the control flow proceeds to step 1-6.

### (Step 1-5)

In step 1-5, a process is performed for incorporating the new electronic mail or social information acquired in step 1-1 to step 1-3 described above into the existing thread into which it has been confirmed in step 1-4 that the new electronic mail or social information can be classified. Subsequently, the control flow proceeds to step 1-7.

### (Step 1-6)

When the control flow proceeds to step 1-6, there exists no thread into which the new electronic mail or social information acquired in step 1-1 to step 1-3 described above can be classified. Therefore, in step 1-6, a new thread is constructed by the thread display processing unit 52. Subsequently, the control flow proceeds to step 1-7.

### (Step 1-7)

In step 1-7, a process is performed for displaying the new electronic mail or social information acquired in step 1-1 to step 1-3 described above such that the new electronic mail or social information is included in the thread determined in step 1-5 or step 1-6. Accordingly, electronic mail and social information handled by the social information processing device 10 are displayed in an identical user interface. Therefore, social information can be handled in the same way as exchange of electronic mail, and can be managed in a unified way.

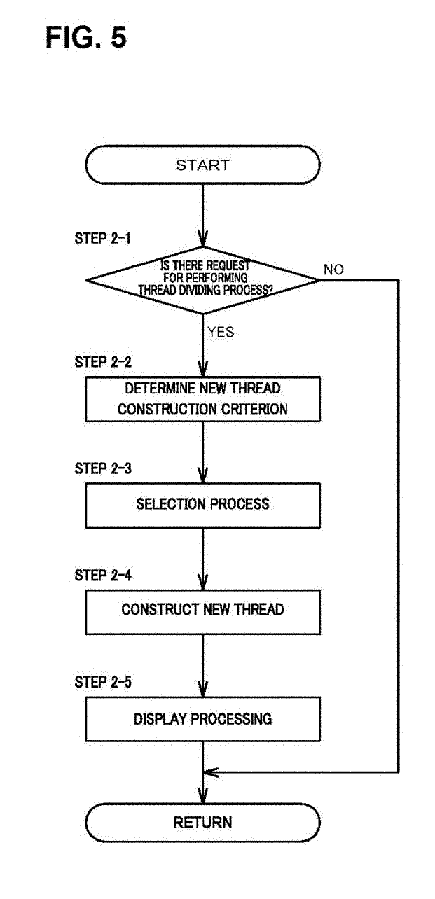

Next, a method for performing a process for collecting part of the electronic mail or social information displayed together in a single thread as described above into another thread independent of the existing thread (thread dividing process) will be described with reference to a flowchart of FIG. 5.

### (Step 2-1)

To begin with, in step 2-1, the new thread construction processing unit 54 checks for the presence of a request for performing the thread dividing process. Specifically, the new thread construction processing unit 54 confirms whether electronic mail or social information to be displayed together in another thread independent of the existing thread has been selected. When it is determined here that there is a request for performing the thread dividing process, the control flow proceeds to step 2-2. On the other hand, when it is determined that there is no request for performing the thread dividing process, a series of steps of the control flow is completed.

### (Step 2-2)

In step 2-2, a process for determining the new thread construction criterion is performed. Specifically, when part of the electronic mail or social information that constitutes the existing thread is selected to be extracted into a new thread, the new thread construction criterion is set up automatically in accordance with a predetermined algorithm by information processing performed by the new thread construction processing unit 54.

### (Step 2-3)

In step 2-3, a process for selecting electronic mail or social information that meets the new thread construction criterion that is set in step 2-2 (selection process) is performed. Subsequently, the control flow proceeds to step 2-4.

### (Step 2-4)

In step 2-4, a process is performed for collecting the electronic mail or social information selected in step 2-3 described above to construct a new thread. After the construction of the new thread is completed, the control flow proceeds to step 2-5.

### (Step 2-5)

In step 2-5, a process is performed for collecting the electronic mail or social information selected in step 2-3 described above into the new thread constructed in step 2-4 for display. Accordingly, a series of steps of the control flow is completed.

As described above, the social information processing device 10 of the present embodiment can extract social information that satisfies the predetermined extraction condition, that is, social information related to the social information processing device 10 itself from social information posted on the Internet toward a large number of general public, by performing the information extraction process. In addition, as illustrated in FIG. 3, the extracted social information can be displayed in the identical user interface to electronic mail related to the electronic mail communication processing. Therefore, the social information processing device 10 can handle social information in the same way as exchange of electronic mail, and can handle social information in a unified way. Accordingly, not only information by electronic mail but also social information posted on the Internet can be used effectively.

Note that the present embodiment has described an example of displaying social information collected in the thread related to electronic mail; however, the present invention is not limited to this example, and relevant electronic mail may be collected and displayed in the thread that displays social information.

In addition, the social information processing device 10 of the present embodiment can send new information by a method such as replying to the social information extracted by the information extraction process. Accordingly, it is possible to smoothly respond to social information posted by a third party on the Internet.

As described above, providing the condition setting processing unit 42 to enable arbitrarily setting of the extraction condition of social information allows social information that meets the desired extraction condition to be extracted securely. This allows more effective use of social information. Note that the present embodiment has described an example in which the condition setting processing unit 42 is provided to enable arbitrary setting of the extraction condition; however, the present invention is not limited to this example, and the extraction condition may be set automatically in accordance with a predetermined algorithm, or the extraction condition may be set automatically as well as arbitrarily. In addition, an estimation processing unit may be separately provided that enables setting of an appropriate extraction condition by estimation processing on the basis of either one or both of the extracted social information and electronic mail.

In addition, the social information processing device 10 of the present embodiment can perform the thread display process for displaying electronic mail and social information that have predetermined relevance to each other collected in a single thread. Therefore, the social information processing device 10 allows social information extracted from the Internet to be read collectively together with relevant electronic mail, further improving convenience.

In addition, the social information processing device 10 of the present embodiment can perform a thread dividing process for displaying electronic mail or social information related to part of the electronic mail or social information that constitutes a thread, collected in another thread independent of the existing thread. This makes it possible to perform thread display of electronic mail and the social information in a form easy for a user to use, further improving convenience. Note that in the present embodiment, the social information processing device 10 capable of performing the thread dividing process has been illustrated; however, the social information processing device 10 may not be able to perform the thread dividing process.

The above-described social information processing device 10 can share electronic mail and social information with other social information processing devices 10 connected to a predetermined network. Therefore, the user can perform work while checking what kind of response users of other social information processing devices 10 have made to electronic mail and social information. This makes it possible to share social information posted on the Internet or electronic mail with other users, further improving work efficiency and convenience.

Note that the present embodiment has described an example assuming that data of electronic mail or social information is stored in the storage medium 22 of the computer 20 that constitutes each social information processing device 10 connected to a network; however, the present invention is not limited to this example. That is, the data of electronic mail or social information may be stored in a server on the network, and each social information processing device 10 may access the server via the network to read the data.

In addition, the above-described social information processing device 10 does not need to handle only electronic mail transmitted and received from a single electronic mail address, and may handle electronic mail transmitted and received from a plurality of electronic mail addresses. In addition, social information handled by the social information processing device 10 does not need to be related to a single social networking service, and social information related to a large number of social networking services may be handled.

In addition, the present embodiment has described an example in which the social information processing program is installed in the computer 20 to perform the method for processing social information; however, the present invention is not limited to this example. Specifically, as in a so-called cloud system, the social information processing program may be able to be executed through installation of the social information processing program in a server provided on a network to which the computer 20 can connect, and access to the server via the network as necessary.

Note that in the present embodiment, electronic mail has been taken up as one example of private message information to be exchanged with a specified party, and the electronic mail communication process and the electronic mail communication processing unit 30 have been illustrated as one example of private information processing that process private message information and the private information processing unit for performing the private information processing; however, the present invention is not limited to this example. Specifically, as private message information, instead of electronic mail or in addition to electronic mail, for example, electronic information or the like that records conversation with a specified party over the telephone or the like can be employed. In addition, the private information processing may be processing of the above-described reply record information such as telephone. Moreover, instead of the electronic mail communication processing unit 30, or in addition to the electronic mail communication processing unit 30, a processing unit for processing the above-described reply record information such as telephone may be provided as a private information processing unit.

In addition, when electronic mail or social information is displayed together in a predetermined user interface as described above, an importance determining function or the like may be mounted that determines automatically, using a keyword or the like included in the electronic mail or the like, whether important information such as complaint is included. In addition, when the importance determining function is mounted, it is desirable to display with priority electronic mail or the like that is determined to have high importance, or to attach an icon indicating that the electronic mail is important, urging a user to pay attention.

### First Example

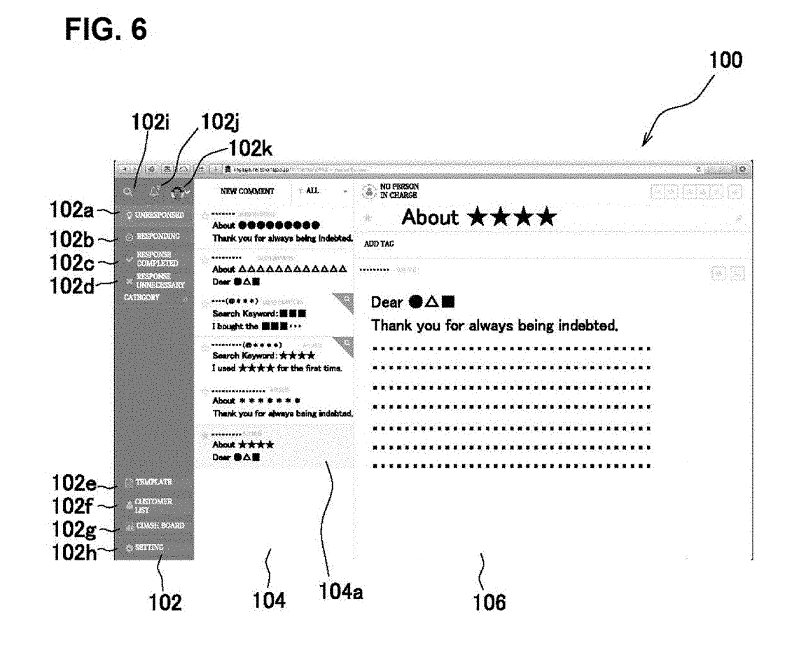

Examples of the above-described social information processing device 10 will be described with reference to FIG. 6 to FIG. 10. FIG. 6 is an initial-state user interface (hereinafter referred to as “top screen 100”) displayed on a monitor, which is the output device 26, in the social information processing device 10 of the present embodiment. While a display form of the top screen 100 may be any form, in the example illustrated in FIG. 6, in a similar manner to the interface illustrated in FIG. 3, the display form of the top screen 100 is a so-called three-pane interface including three regions, a left pane 102, a central pane 104, and a right pane 106. Menu buttons are displayed in a vertical arrangement in the left pane 102 of the top screen 100.

Specifically, in the example illustrated in FIG. 6, as buttons that are set for respective response situations to electronic mail and social information, an unresponded menu button 102a, a responding menu button 102b, a response completed menu button 102c, and a response unnecessary menu button 102d are prepared. In addition, as buttons for calling a template for creating electronic mail or the like and a customer list, a template button 102e and a customer list button 102f are provided. Furthermore, as buttons for calling a dashboard screen 120, which will be described later, and a setting screen (not illustrated), a dashboard button 102g and a setting button 102h are provided. In addition, on an upper side of the left pane 102, an extraction condition setting button 102i for setting the extraction condition in the condition setting processing unit 42 of the social information processing unit 40, and a notification icon 102j for notifying the presence of newly arrived information are provided. In addition, when there is unresponded electronic mail or the like, the total number thereof is displayed beside the notification icon 102j or the unresponded menu button 102a. The number of unresponded electronic mails or the like displayed beside the notification icon 102j or the unresponded menu button 102a is an index indicating a processing state of work managed by the social information processing device 10. Therefore, when response is made so as to decrease the number of unresponded cases to zero, the work managed by the social information processing device 10 will progress without delay. In addition, an account button 102k is provided that functions as a button for account switching while displaying a thumbnail image indicating a currently used user account.

The central pane 104 is a region for performing list display of a thread 104a. In the example illustrated in FIG. 6, the thread 104a including electronic mail and the like corresponding to the selected menu is list-displayed in the central pane 104 from among the unresponded menu button 102a, the responding menu button 102b, the response completed menu button 102c, and the response unnecessary menu button 102d. In addition, when one of the thread 104a displayed in the central pane 104 is selected, contents of the electronic mail or the like that constitutes the thread 104a is displayed in the right pane 106.

In a state where the top screen 100 illustrated in FIG. 6 is displayed, in addition to creating, transmitting, and receiving electronic mail, it is possible to reply to social information and send citations. In addition, when the unresponded menu button 102a is selected from among the menus displayed in the left pane 102 on the top screen 100, unresponded electronic mails received from other people and social information that is extracted and unresponded are list-displayed in the central pane 104. Similarly, when the responding menu button 102b is selected, electronic mail or the like that is being responded is list-displayed in the central pane 104. In addition, when the response completed menu button 102c is selected, electronic mail or the like to which response is completed is list-displayed in the central pane 104, and when the response unnecessary menu button 102d is selected, electronic mail or the like that does not need further response is list-displayed in the central pane 104.

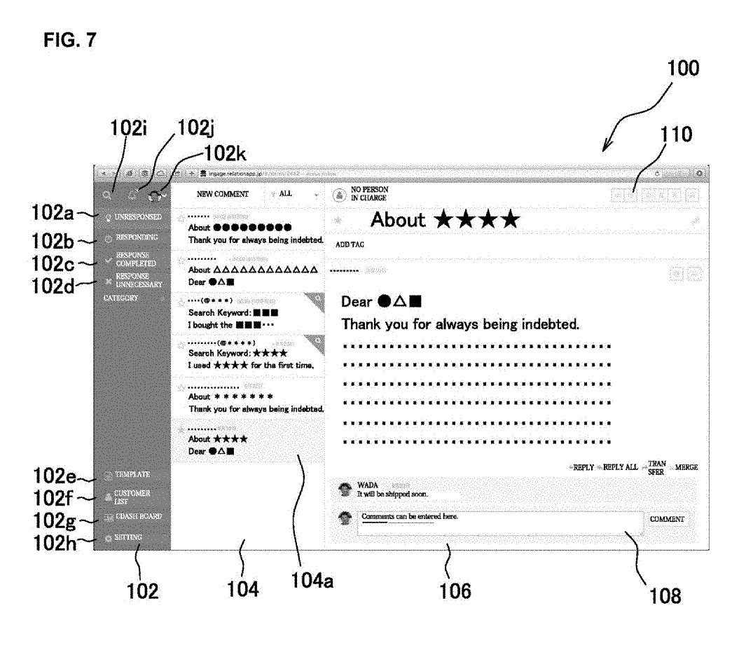

In addition, as illustrated in FIG. 7, when an electronic mail or the like list-displayed in the central pane 104 is selected, contents of the electronic mail or the like is displayed in the right pane 106, and a comment column 108 is displayed. The comment column 108 is provided for exchanging comments among users who have been registered to use the social information processing device 10. The comments entered in the comment column 108 can be read among other users sharing the social information processing device 10, and other people who are exchanging electronic mail or the like cannot read the comments.

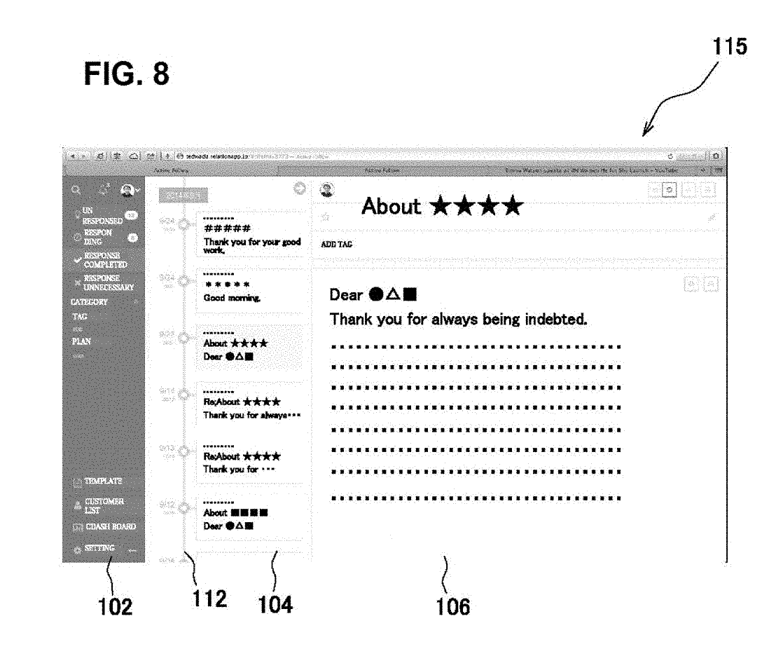

In addition, as illustrated in FIG. 7, when an electronic mail or the like list-displayed on the central pane 104 is selected, a timeline display button 110 is displayed. The timeline display button 110 is a button to be used to display, in a time-series arrangement, exchange with a specific party who is exchanging the selected electronic mail or the like. When the timeline display button 110 is selected, a timeline display screen 115 as illustrated in FIG. 8 is displayed. On the timeline display screen 115, electronic mail or the like exchanged with a specific party is list-displayed (timeline display) in a time-series arrangement along a time axis 112.

In a state of FIG. 8, when an electronic mail or the like that is timeline-displayed in the central pane 104 is selected, detailed contents of the electronic mail or the like is displayed in the right pane 106. This allows the user to exchange a next electronic mail or the like while reading a record of the electronic mail or the like that has been exchanged with a specific party in the past. That is, a mailer or the like of a conventional technology allows the user to take a look at a transmission-reception record of electronic mail or the like on the basis of transmission-reception date and time or subject. However, the mailer or the like does not allow the user, while arranging electronic mail or the like in time-series order on the basis of a specific party for transmission and reception without depending on the subject, to check contents of the electronic mail or the like. In the example illustrated in FIG. 8, it is possible to list-display electronic mail or the like exchanged with a specific party for transmission and reception in time-series arrangement (timeline display) without depending on the subject. Also, it is possible to display detailed contents thereof in the right pane 106, or to transmit and receive new electronic mail or the like. Therefore, it is possible, while tracing the transmission-reception record that has been made in the past, to easily make a response on the basis of the record.

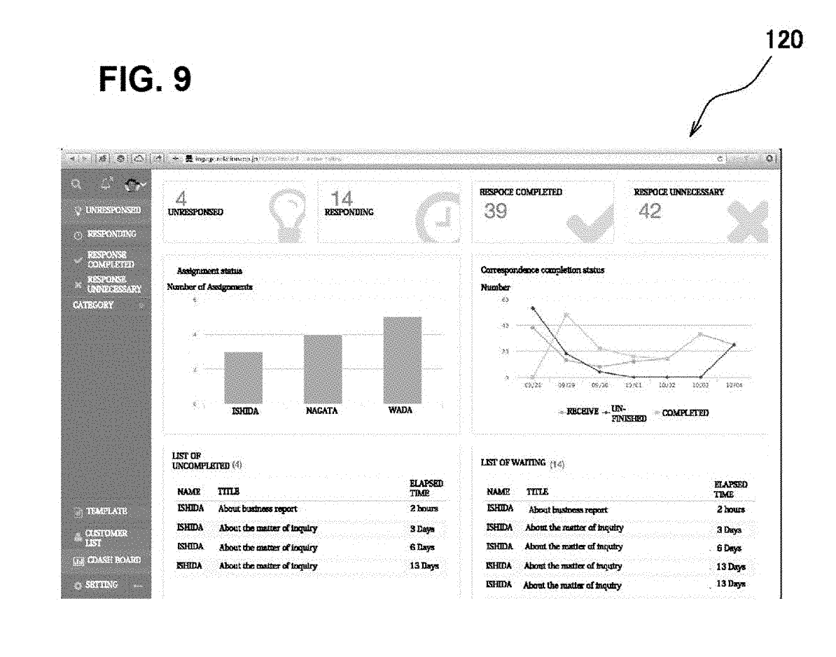

In addition, when the above-described dashboard button 102g is selected, the dashboard screen 120 as illustrated in FIG. 9 is displayed. The dashboard screen 120 allows the user to take a look at information on electronic mail or social information handled by the social information processing device 10. Specifically, the dashboard screen 120 can collectively display information such as a graph indicating an assignment situation and a response situation, a list of unresponded electronic mail and the like, and a list of electronic mail waiting for reply.

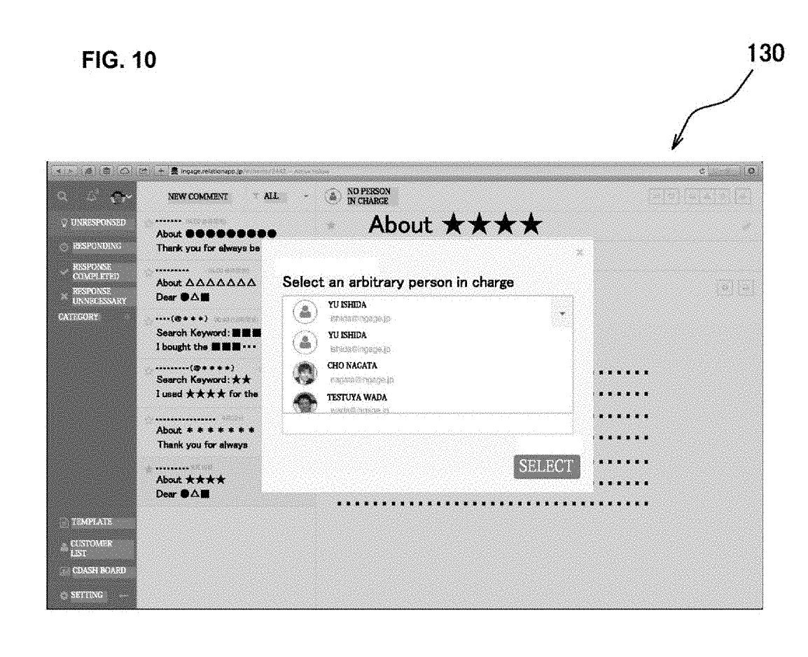

In addition, the social information processing device 10 has a function to sort each electronic mail or the like to a person in charge. Specifically, when there is an electronic mail to be sorted to a person in charge in the top screen 100 or the like, it is possible to call a person in charge sorting interface 130 as illustrated in FIG. 10 and select an arbitrary person in charge from a list displayed.

In addition, when it is desired to make various settings in the social information processing device 10, it is possible to call a setting screen (not illustrated) by selecting the setting button 102h. It is possible to set operating conditions and the like of the social information processing device 10 by appropriately selecting a menu displayed on this screen.

In addition to the above-described functions, the social information processing device 10 can have a function, when the user registered in the social information processing device 10 sends electronic mail or social information, to disable the sending as long as another user, such as an administrator, does not provide approval in advance (approval function). Accordingly, for example, it is possible to inhibit the user of the social information processing device 10 who is unfamiliar with work from sending unexpected electronic mail or social information. In addition, when the approval function is mounted, a function to send back electronic mail or the like to a user who is trying to send electronic mail or the like the administrator cannot approve may further be mounted.

### Second Embodiment

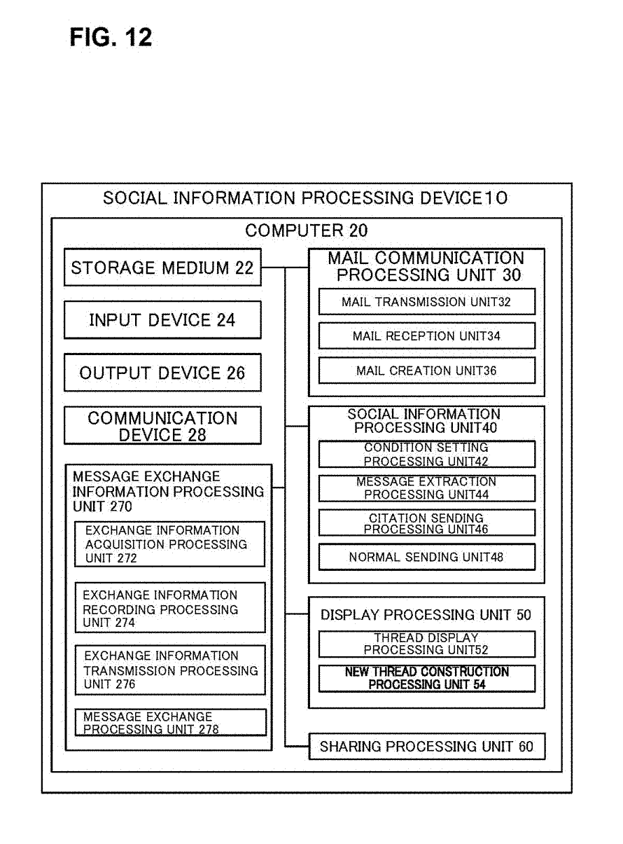

Next, a social information processing device 210, a social information processing program, and a method for processing social information according to a second embodiment of the present invention will be described in detail with reference to the drawings. In a similar manner to a social information processing device 10 according to a first embodiment, the social information processing device 210 performs the method for processing social information according to the second embodiment of the present invention. Functional components as illustrated in FIG. 12 are constructed in a computer 220 by installing the social information processing program of the present invention in a storage medium 222, such as a hard disk or a solid state drive (SSD), included in the computer 220. The social information processing device 210 can be used via an input device 224 included in the computer 220, such as a mouse and a keyboard, or an output device 226, such as a monitor. In addition, via a communication device 228 included in the computer 220, the social information processing device 210 can connect to a communication network and perform communication, such as an Internet network, a local area network (LAN), a wide area network (WAN), and a virtual private network (VPN).

FIG. 12 is a block diagram illustrating one example of functional components of the social information processing device 210. In a similar manner to the social information processing device 10, the social information processing device 210 includes an electronic mail communication processing unit 230 (private information processing unit), a social information processing unit 240, a display processing unit 250, and a sharing processing unit 260 as functional components. In addition, the social information processing device 210 includes a message exchange information processing unit 270 as a functional component.

The electronic mail communication processing unit 230 has a configuration and function similar to a configuration and function of an electronic mail communication processing unit 30 of the social information processing device 10 according to the first embodiment. The electronic mail communication processing unit 230 performs a process similar to a process of the electronic mail communication processing unit 30 (electronic mail communication processing, private information processing).

Moreover, an electronic mail creation unit 236 of the electronic mail communication processing unit 230 can perform a process for automatically adding a link for participating in a message exchange site, such as a chat site, to a created electronic mail. Accordingly, a recipient who has received the electronic mail transmitted from an electronic mail transmission unit 232 of the social information processing device 210 can exchange information in real time with users of the social information processing device 210 via the message exchange site, even if the recipient is not a user of the social information processing device according to the present embodiment.

In a similar manner to a social information processing unit 40 of the social information processing device 10 according to the first embodiment, the social information processing unit 240 processes social information posted on the Internet, and has a function similar to a function of the social information processing unit 40.

The social information processing unit 240 includes components such as a condition setting processing unit 242, an information extraction processing unit 244, a reply-citation sending processing unit 246, and a normal sending unit 248. The condition setting processing unit 242, the information extraction processing unit 244, the reply-citation sending processing unit 246, and the normal sending unit 248 have configurations and functions similar to configurations and functions of respective processing units of the social information processing unit 240 according to the first embodiment. Social information handled by the social information processing unit 40 is processed by the display processing unit 250, which will be described in detail later, so as to be displayable in a predetermined user interface. The social information is then displayed together with electronic mail on the output device 226, such as a monitor.

Moreover, the normal sending unit 248 of the social information processing unit 240 can perform the process for automatically adding the link for participating in the message exchange site to a normal post on a service or website, such as mini blogs and SNS. This allows other users of mini blogs, SNS, or the like to exchange information in real time with users of the social information processing device 210 via the message exchange site.

The message exchange information processing unit 270 performs a process about message exchange information using the message exchange site, such as so-called chat. The message exchange information processing unit 270 has a function to acquire the message exchange information from the message exchange site such as a chat site, and to handle the acquired message exchange information in a similar manner to electronic mail. Here, the message exchange information refers to a message transmitted and received in real time via the Internet. The message is information sent to a specific party in a similar manner to electronic mail, and is promptly checked and replied without performing work such as opening. That is, the message is information for purposes of being exchanged in real time, and the work of exchange (reply) is performed more simply and easily than electronic mail. The message exchange information handled by the message exchange information processing unit 270 is processed by the display processing unit 250 so as to be displayable in a predetermined user interface, and then displayed on the output device 226, such as a monitor, together with electronic mail and social information.

An exchange information acquisition processing unit 272 performs a process for acquiring the message exchanged via the Internet (exchange information acquisition processing). Message exchange in the message exchange site is performed by mutually transmitting a user's message and the other party's message. Since the message exchange site displays each message in the order received, a user of the chat site can transmit a next message of the user while checking the message of the other party in real time. Therefore, in the chat site, the user can exchange messages as easily as talking with the other party. In connection with this, the exchange information acquisition processing unit 272 acquires the other party's message and the user's message from the chat site sequentially on a time-series basis. In addition, when a predetermined time has elapsed since the latest message of the continuously exchanged messages, the exchange information acquisition processing unit 272 recognizes the latest message to be the final message, and recognizes a large number of messages exchanged by the final message as one group. Hereinafter, this one group of message is referred to as “bundle of messages.”

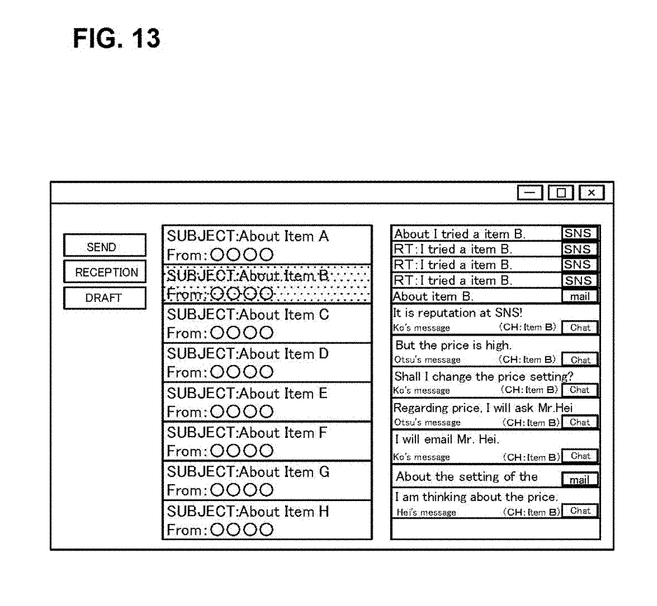

An exchange information recording processing unit 274 sequentially records the message the exchange information acquisition processing unit 272 acquires from the chat site as a record concerning the message exchange information. The message recorded by the exchange information recording processing unit 274 is processed by the display processing unit 250, which will be described in detail later, so as to be displayable in a predetermined user interface. Then, as illustrated in FIG. 13, each message is displayed on the output device 226, such as a monitor, together with electronic mail. In addition, the exchange information recording processing unit 274 may record the bundle of messages, which is the group of the plurality of messages acquired by the exchange information acquisition processing unit 272, as a record concerning the message exchange information.

In cooperation with an electronic mail transmission unit 232, an exchange information transmission processing unit 276 transmits the record concerning the message exchange information recorded by the exchange information recording processing unit 274 to a party with whom the message has been exchanged. The record concerning the message exchange information to be transmitted may be, for example, contents of the bundle of messages themselves, or may be only a message history of the bundle of messages (time-series information). Accordingly, not only the user of the social information processing device 210 but also the party with whom the message has been exchanged can acquire the record concerning the message exchange information, and can check the message exchange information by a method similar to electronic mail check without accessing the chat site again. Note that although the present embodiment has illustrated transmission of the record concerning the message exchange information to other users, the transmission of the record on the message exchange information is not essential. For example, the present embodiment can be adapted to avoid transmission when the party with whom the message has been exchanged does not desire the transmission.

As is conventionally well known, a message exchange processing unit 278 has a function to connect to the chat site and perform chat.

In the present embodiment, although the exchange information acquisition processing unit 272 sequentially acquires messages from chat, the exchange information acquisition processing unit 272 may acquire the plurality of messages collectively after the chat is finished. In this case, the message exchange information recording processing unit 274 records information acquired collectively as a bundle of messages.

In a similar manner to a display processing unit 50 of the social information processing device 10 according to the first embodiment, the display processing unit 250 processes electronic mail and social information processed by the electronic mail communication processing unit 230 and the social information processing unit 240 so as to be displayable in a predetermined user interface in the output device 226, such as monitor. Moreover, in addition to electronic mail and social information, the display processing unit 250 can display message exchange information together in the identical user interface. The display processing unit 250 includes a thread display processing unit 252 and a new thread construction processing unit 254.

The thread display processing unit 252 and the new thread construction processing unit 254 have configurations and functions similar to configurations and functions of a thread display processing unit 52 and a new thread construction processing unit 54 of the social information processing device 10 according to the first embodiment.

The thread display processing unit 252 performs a process for selecting electronic mail, social information, and message exchange information that have predetermined relevance to one another, and performing display together as a single thread, for example, in a form illustrated in FIG. 13 (thread display process). When a reply or citation post is made to a first electronic mail, social information, or message exchange information that describes predetermined information, the thread display processing unit 252 forms a thread automatically. In addition, when another reply or citation post is further made to this reply or citation post, the thread display processing unit 252 collects this reply or citation post into the thread formed earlier. In this way, the thread display processing unit 252 collects electronic mail, social information, or message exchange information into an existing thread or constructs a new thread.

Here, the relevance of electronic mail, social information, or message exchange information that serves as a criterion for constructing a thread (hereinafter also referred to as “thread construction criterion”) can be set on various conditions. Specifically, various conditions can be employed as the thread construction criterion, such as a predetermined keyword specified by a user being included in a title (subject name) or body text, date and time when the social information is posted, gender of a person who makes the post, positional information where the post is made, and furthermore, a channel to which the message exchange information belongs. A user may be allowed to arbitrarily set the thread construction criterion, or the thread display processing unit 252 may set the thread construction criterion automatically in accordance with a predetermined algorithm.

The new thread construction processing unit 254 performs a process for collecting electronic mail or social information related to part of electronic mail, social information, or message exchange information that constitutes an existing thread into another thread independent of the existing thread for display (thread dividing process). Specifically, when the new thread construction processing unit 254 selects part of electronic mail or social information that constitutes an existing thread, the new thread construction processing unit 254 sets a new thread construction criterion (hereinafter also referred to as “new thread construction criterion”) on the basis of the selected electronic mail, social information, or message exchange information. From the electronic mail, social information, or message exchange information that constitutes the existing thread, the new thread construction processing unit 254 performs a process for selecting electronic mail, social information, or message exchange information that meets the new thread construction criterion, and then collecting the selected electronic mail, social information, or message exchange information into another thread for display.

As described earlier, as the message exchange information, a plurality of messages may be collectively acquired after chat is finished. In this case, these collectively acquired messages may become a record concerning the message exchange information as a bundle of messages, and may be displayed in a thread as one electronic mail. In addition, in this case, the exchange information transmission processing unit 276 may send the bundle of messages as it is to a partner of chat, or may send part of information on the bundle of messages.

The sharing processing unit 260 performs a process for sharing information about electronic mail, social information, or message exchange information among a plurality of social information processing devices 210 connected to a predetermined network. Specifically, data of electronic mail or social information is synchronized among the plurality of social information processing devices connected to a communications network, such as a local area network (LAN), a wide area network (WAN), and a virtual private network (VPN). Accordingly, even when exchange of electronic mail, social information, or message exchange information is made in any social information processing device connected to the network, the information can be checked by other social information processing devices 210 as well.

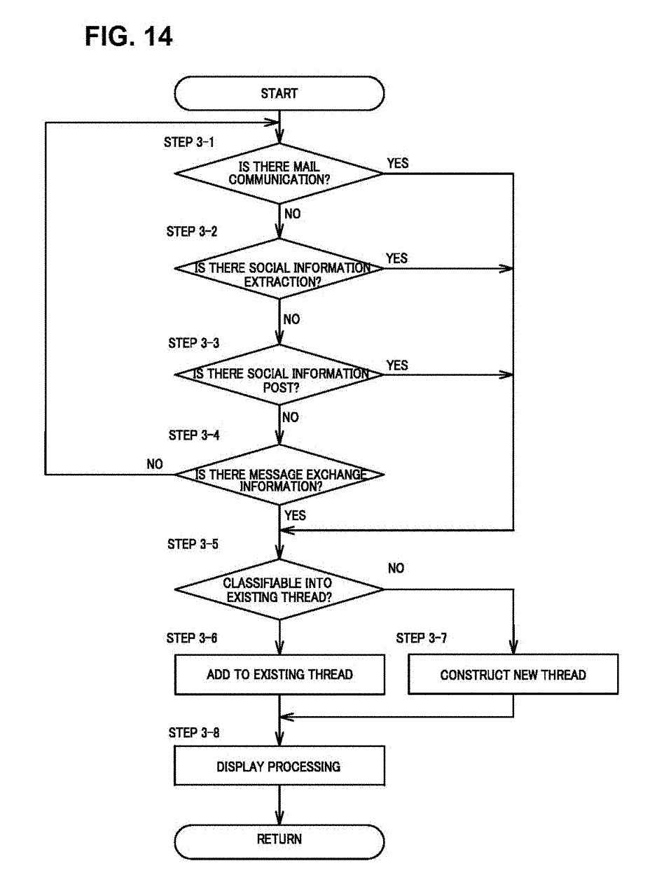

Next, in the method for processing social information to be performed by the above-described social information processing device 210, an information processing flow of displaying electronic mail, social information, and message exchange information in a thread will be described in detail with reference to a flowchart of FIG. 14.

### (Step 3-1)

To begin with, in step 3-1, it is confirmed whether communication (transmission and reception) of electronic mail has been carried out by the electronic mail communication processing unit 230. When communication by electronic mail has been carried out, a control flow proceeds to step 3-5, whereas when communication by electronic mail has not been carried out, the control flow proceeds to step 3-2.

### (Step 3-2)

In step 3-2, it is confirmed whether social information that meets an extraction condition that is set in advance has been extracted by the information extraction processing unit 244 of the social information processing unit 240. Here, when it is confirmed that new social information has been extracted, the control flow proceeds to step 3-5. On the other hand, when new social information has not been extracted, the control flow proceeds to step 3-3.

### (Step 3-3)

In step 3-3, it is confirmed whether a user of the social information processing device 210 has posted social information with the reply-citation sending processing unit 246 or the normal sending unit 248 of the social information processing unit 240. Here, when it is confirmed that social information has been posted, the control flow proceeds to step 3-5. On the other hand, when it is not confirmed that social information has been posted by the user of the social information processing device 210, the control flow proceeds to step 3-4.

### (Step 3-4)

In step 3-4, it is confirmed whether the message exchange information processing unit 270 has acquired the message exchange information from a chat site. Here, when it is confirmed that new message exchange information has been acquired, the control flow proceeds to step 3-5. On the other hand, when new message exchange information has not been extracted, the control flow returns to step 3-1.

### (Step 3-5)

In step 3-5, the thread display processing unit 252 confirms whether the electronic mail, social information, or message exchange information newly confirmed in step 3-1 to step 3-4 described above can be classified into an existing thread. That is, it is confirmed whether the new electronic mail, social information, or message exchange information confirmed in step 3-1 to step 3-4 meets a classification condition into an existing thread (thread construction criterion). Here, when the new electronic mail, social information, or message exchange information can be classified into an existing thread, the control flow proceeds to step 3-6, whereas when the new electronic mail, social information, or message exchange information cannot be classified into an existing thread, the control flow proceeds to step 3-7.

### (Step 3-6)

In step 3-6, a process is performed for incorporating the new electronic mail, social information, or message exchange information acquired in step 3-1 to step 3-4 described above into the existing thread into which it has been confirmed in step 3-5 that the new electronic mail, social information, or message exchange information can be classified. Subsequently, the control flow proceeds to step 3-8.

### (Step 3-7)

When the control flow proceeds to step 3-7, there exists no thread into which the new electronic mail, social information, or message exchange information acquired in step 3-1 to step 3-4 described above can be classified. Therefore, in step 3-7, a new thread is constructed by the thread display processing unit 252. Subsequently, the control flow proceeds to step 3-8.

### (Step 3-8)

In step 3-8, a process is performed for displaying the new electronic mail, social information, or message exchange information acquired in step 3-1 to step 3-4 described above such that the new electronic mail, social information, or message exchange information is included in the thread determined in step 3-6 or step 3-7. Accordingly, electronic mail, social information, and message exchange information handled by the social information processing device 210 are displayed in an identical user interface. Therefore, social information can be handled in the same way as exchange of electronic mail, and can be managed in a unified way.

The new thread construction processing unit 254 processes a method for performing a process for displaying, together in another thread independent of the existing thread, part of the electronic mail or social information displayed together in a single thread as described above, and the message exchange information (thread dividing process). This process is similar to the process to be performed by the new thread construction processing unit 54 described above, and thus description thereof will be omitted.

In addition, the social information processing device 210 of the present embodiment can perform the thread display process for displaying electronic mail, social information, and message exchange information that have predetermined relevance to each other together in a single thread. Therefore, the social information processing device 210 can simply and easily exchange information by using the message exchange information processing unit 270 for electronic mail and social information. Accordingly, it is possible to more smoothly respond to social information posted by a third party on the Internet.

The above-described social information processing device 210 can share electronic mail, social information, and message exchange information with other social information processing devices 210 connected to a predetermined network. Therefore, the user can perform work while checking what kind of response users of other social information processing devices 210 have made to electronic mail, social information, and message exchange information. This makes it possible to share social information posted on the Internet, electronic mail, or message exchange information with other users, further improving work efficiency and convenience.

Note that the present embodiment has described an example assuming that data of electronic mail or social information is stored in the storage medium 222 of the computer 220 that constitutes each social information processing device 210 connected to a network; however, the present invention is not limited to this example. That is, the data of electronic mail or social information may be stored in a server on the network, and each social information processing device 210 may access the server via the network to read the data.

In addition, the above-described social information processing device 210 does not need to handle only electronic mail transmitted and received from a single electronic mail address, and may handle electronic mail transmitted and received from a plurality of electronic mail addresses. In addition, the social information processing device 210 does not need to handle message exchange information related to a single chat site, and may handle message exchange information related to a large number of chat sites.

In addition, the present embodiment has described an example in which the social information processing program is installed in the computer 220 to perform the method for processing social information; however, the present invention is not limited to this example. Specifically, as in a so-called cloud system, the social information processing program may be able to be executed through installation of the social information processing program in a server provided on a network to which the computer 220 can connect, and access to the server via the network as necessary.

Note that electronic mail has been taken up as one example of private message information to be exchanged with a specified party, and the electronic mail communication process and the electronic mail communication processing unit 230 have been illustrated as one example of private information processing that processes private message information and the private information processing unit for performing the private information processing; however, the present invention is not limited to this example. Specifically, as private message information, instead of electronic mail or in addition to electronic mail, for example, electronic information or the like that records conversation with a specified party over the telephone or the like can be employed. In addition, the private information processing may be processing of the above-described reply record information such as telephone. Moreover, instead of the electronic mail communication processing unit 230, or in addition to the electronic mail communication processing unit 230, a processing unit for processing the above-described reply record information such as telephone may be provided as a private information processing unit.

In addition, when electronic mail or social information is displayed together in a predetermined user interface as described above, an importance determining function or the like may be mounted that determines automatically, using a keyword or the like included in the electronic mail or the like, whether important information such as complaint is included. In addition, when the importance determining function is mounted, it is desirable to display with priority electronic mail or the like that is determined to have high importance, or to attach an icon indicating that the electronic mail is important, urging a user to pay attention.

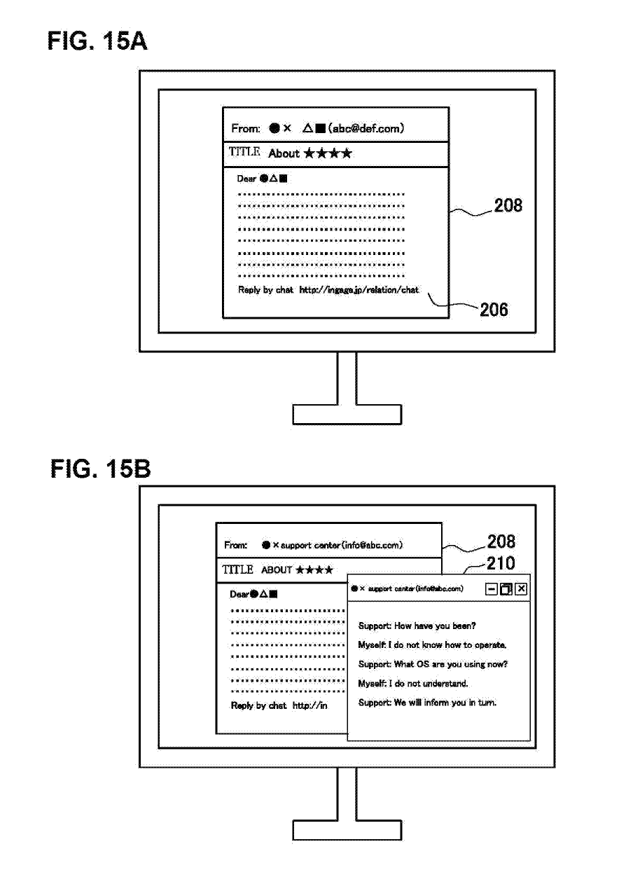

An electronic mail to which a link has been automatically added from the information processing device 210 according to the present embodiment to a message exchange site will be described with reference to FIGS. 15A and 15B. FIGS. 15A and 15 B are typical user interface 200 of electronic mail communication processing displayed on a monitor, which is an output device of a computer of a general user (guest user) who is exchanging electronic mail or the like.

Link information 206 that links to a message exchange site, such as a chat site, is added to an electronic mail transmitted from the information processing device 210. Specifically, in an example illustrated in FIG. 15A, URL information linking to the message exchange site is added as the link information 206 together with character information of “reply by chat.” The link information 206 provides a method, when a guest user, that is, a user who is exchanging mail or the like without the user himself or herself using the information processing device 210 wants to continue conversation, for having conversation by a method using the message exchange site, such as chat, as a method other than replying as an electronic mail or a post on SNS. In other words, the link information 206 is guest connection permission information that temporarily grants connection authority even to the guest user who does not have authority to connect to the message exchange site, and clicking the link information 206 allows connection to the message exchange site. Meanwhile, when a registered user who already has connection authority to the message exchange site clicks a chat site participating button, the user can naturally connect to the message exchange site as a registered user.

Connection to the chat site to which the link information 206 links allows a recipient of the electronic mail to exchange messages in real time via the message exchange site such as the chat site. Specifically, as illustrated in FIG. 15B, a window for chat (chat window 210) opens other than a window for software (mailer) for transmitting and receiving mail (mailer window 208). Although the chat window 210 may be a window dedicated for chat, the chat window 210 may be constructed using a browser or the like installed in a terminal the guest user is using. When the chat window 210 opens, information can be exchanged in real time by chat within this window.

As described earlier, the social information processing device 210 according to the present invention can transmit a record concerning the message exchange information to a party with whom the message has been exchanged as private message information. When the party with whom the message has been exchanged connects to the message exchange site on the basis of the guest connection permission information, the social information processing device 210 can identify the electronic mail to which the guest information permission information has been added, and transmit the record concerning the message exchange information by regarding a destination of the electronic mail as the party with whom the message has been exchanged.

In the example described above, as the link information 206, URL information having a link is added together with the character information of “reply by chat”; however, the present invention is not limited to this example. The character information indicating the link information 206 may be indicated by another wording or in another form, as long as the character information allows the user to recognize a method using the message exchange site, such as chat. Specifically, another character information having a link other than URL may be added as the link information 206, or the link information 206 may be indicated in a form of button, icon, or the like that links to the message exchange site.

In addition, the button, icon, or the like indicating the link information 206 not only is provided with the link for using the message exchange site, but also may be able to complexly display another information, such as whether the user of the social information processing device 210 can participate in message exchange. For example, color, pattern, shape of the button, icon, or the like indicating the link information 206 may be changed depending on whether the user of the social information processing device 210, who is a conversation partner, can participate in chat or not. In more detail, when the user of the social information processing device 210 can participate in chat, the button or icon to which the link information 206 is added may be displayed in green, whereas when the user of the social information processing device 210 cannot participate in chat, the button or icon may be displayed in red. Alternatively, the user interface of the message exchange site to which guidance is provided on the basis of the link information 206 may display whether the user of the social information processing device 210 can participate in the message exchange site.

Furthermore, when the guest user is guided to the message exchange site on the basis of the link information 206 while the user of the social information processing device 10, 210 is absent, the guest user may be automatically notified of absence of the user of the social information processing device, and the user of the social information processing device may be automatically notified of another user being guided to the message exchange site by electronic mail.

In addition, the social information processing device 10, 210 may be provided with a function, in a case where it is estimated that the user of the social information processing device 10, 210 is absent, such as in a case where there is no reply for a certain period of time even when the guest user calls the user of the social information processing device 10, 210 via the message exchange site, such as chat, the function to inquire the guest user whether to leave a message (absence message) to the user of the social information processing device 10, 210 (absence message necessity check), for example, to display a message such as “The person in charge is absent. Do you desire to leave a message instead?”, and to be able to leave the absence message in response to the guest user's request. Note that the social information processing device 10, 210 may not have a function to estimate whether the user of the social information processing device 10, 210 is absent. In addition, without performing the absence message necessity check, on condition that it is estimated that the user of the social information processing device 10, 210 is absent because, for example, there is no reply for a certain period of time, the absence message may be left without performing the absence message necessity check.

### INDUSTRIAL APPLICABILITY

The social information processing program, the social information processing device, and the method for processing social information of the present invention can be effectively used for applications such as promptly acquiring social information in which customer information is posted on the Internet and responding at an early stage, for example, in company sites such as sales activities and customer support.

1. A social information processing program capable of performing:
private information processing for processing private message information to be exchanged with a specified party;
message extraction processing for extracting social information that satisfies a predetermined extraction condition from social information posted on Internet; and
display processing capable of displaying the social information extracted by the message extraction processing in an identical user interface to the private message information related to the private information processing.

2. The social information processing program according to claim 1, wherein
electronic mail communication processing related to communication by electronic mail is included in the private information processing, and
the electronic mail is handled as part or all of the private message information.

3. The social information processing program according to claim 1, further capable of performing one or both of:
reply processing for sending new social information related to a reply to the social information extracted by the message extraction processing; and
citation sending processing for sending new social information that cites the extracted social information.

4. The social information processing program according to claim 1, further capable of arbitrarily performing condition setting processing for setting the extraction condition.

5. The social information processing program according to claim 1, further capable of performing thread display processing for displaying the private message information and the social information having predetermined relevance to each other together in a single thread.

6. The social information processing program according to claim 5, further capable of performing thread dividing processing for displaying part of the private message information or the social information constituting the thread, and the private message information and the social information related thereto, together in a different thread independent of an existing thread.

7. The social information processing program according to claim 1, wherein the private message information and the social information can be shared among computers connected to a predetermined network.

8. The social information processing program according to claim 1, further capable of performing:
estimation processing based on one or both of the social information extracted by the message extraction processing and the private message information; and
setting of the extraction condition based on a result of performing the estimation processing.

9. The social information processing program according to claim 1, further capable of performing exchange information acquisition processing for acquiring message exchange information to be exchanged in real time via the Internet,
wherein the display processing is capable of displaying the message exchange information acquired by the exchange information acquisition processing in the identical user interface.

10. The social information processing program according to claim 9, further capable of granting, to the private message information or the social information, guest connection permission information for temporarily granting, to a guest user who does not have connection authority to a specified message exchange site for exchanging the message exchange information, the connection authority.

11. The social information processing program according to claim 10, further capable of transmitting, to the guest user, a record concerning the message exchange information recorded by connecting to the specified message exchange site based on the guest connection permission information, as private message information.

12. The social information processing program according to claim 9, further capable of performing exchange information transmission processing for transmitting a record concerning the message exchange information as private message information.

13. A social information processing device comprising:
a private information processing unit configured to perform private information processing related to private message information to be exchanged with a specified party;
a message extraction processing unit configured to extract social information that satisfies a predetermined extraction condition from social information posted on Internet; and
a display processing unit capable of displaying the social information extracted by the message extraction processing unit in an identical user interface to the private message information related to the private information processing.

14. The social information processing device according to claim 13, further comprising an exchange information acquisition processing unit configured to perform exchange information acquisition processing for acquiring message exchange information to be exchanged in real time on Internet,
wherein the display processing unit is capable of displaying the message exchange information acquired by the exchange information acquisition processing unit in the identical user interface.

15. A method for processing social information, the method comprising:
performing private information processing related to private message information to be exchanged with a specified party;
performing message extraction processing for extracting social information that satisfies a predetermined extraction condition from social information posted on Internet; and
performing display processing capable of displaying the social information extracted by the message extraction processing in an identical user interface to the private message information related to the private information processing.

16. The method for processing social information according to claim 15, further capable of performing exchange information acquisition processing for acquiring message exchange information to be exchanged in real time on the Internet,
wherein the display processing is capable of displaying the message exchange information acquired by the exchange information acquisition processing in the identical user interface.
